(19) United States
(12) Patent Application Publication
(10) Pub. No.: US 2016/0103203 A1
(43) Pub. Date: Apr. 14, 2016

(54) METHOD AND SYSTEM FOR DETERMINING POSITION OF A WIRELESS ELECTRONIC DEVICE WITHIN A VOLUME

(71) Applicant: Intelligent Sciences, Ltd., Paradise (CA)

(72) Inventors: Nicholas G. Pace, Bath (GB); Jacques Y. Guigné, Paradise (CA)

(21) Appl. No.: 14/878,296

(22) Filed: Oct. 8, 2015

Related U.S. Application Data
(60) Provisional application No. 62/061,245, filed on Oct. 8, 2014.

(51) Int. Cl. G01S 5/26

(52) U.S. Cl. CPC G01S 5/26

(57) ABSTRACT

A system for locating a mobile electronic device includes a plurality of acoustic transmitters arranged in a selected pattern within a volume. A first processor is in signal communication with each of the acoustic transmitters. The processor is programmed to drive each of the transmitters with a different coded signal. The signals are substantially decorrelated with each other. An electromagnetic signal transceiver is in signal communication with the processor. The processor is programmed to communicate a time reference signal to the mobile electronic device. The mobile device includes an acoustic receiver for detecting signals from the transmitters and an electromagnetic transceiver for receiving the time reference signal. The mobile device includes a second processor programmed for cross-correlating signals detected by the acoustic receiver with a replica of each of the different coded signals. The second processor has instructions programmed therein for calculating an acoustic travel time of acoustic signals between each transmitter and the acoustic receiver from the cross-correlated signals. At least one of the first processor and the second processor is programmed to determine the position of the mobile electronic device from the travel times.

### CROSS REFERENCE TO RELATED APPLICATIONS

Priority is claimed from U.S. Provisional Application No. 62/061,245 filed on Oct. 8, 2014.

### STATEMENT REGARDING FEDERALLY SPONSORED RESEARCH OR DEVELOPMENT

Not Applicable.

### NAMES TO THE PARTIES OF A JOINT RESEARCH OR DEVELOPMENT AGREEMENT

Not Applicable.

### BACKGROUND

This disclosure is related to the field of location detection of mobile electronic devices within a volume. More specifically the disclosure relates to methods and systems for location of such mobile devices using acoustic signals that are inaudible by humans and are relatively free of effects of background noise.

U.S. Pat. No. 7,796,471 issued to Guigné et al. describes an example method and system for using acoustic signals to determine position of a mobile electronic device within a volume. The method described in the foregoing patent includes emitting an acoustic pulse from the position of the mobile electronic device. The acoustic pulse is detected at known positions comprising three spaced apart locations along each of at least two lines extending in different directions. The range and phase difference of the acoustic pulse between each of the detecting locations is determined. A relative position of the device with respect to the known position is obtained from the range and phase differences.

### BRIEF DESCRIPTION OF THE DRAWINGS

FIG. 1 shows an example of a base unit and a mobile electronic device.

FIG. 2 shows an example base station source containing eight acoustic transmitters on the circumference of a circle of diameter 16 cm surrounding a central transmitter. The central transmitter is located at a position defined by the coordinates (0,0,r_{z}).

FIG. 3A shows examples of 9 coded signal sequences as transmitted, bandpass filtered to between 5 kHz and 15 kHz. The signal duration is 0.25 seconds and the signal digital sampling frequency is 96 kHz.

FIG. 3B shows a time-expanded view of the sample signals of FIG. 3A.

FIG. 4A shows the total signal arriving at the receiver due to the transmissions from the 9 transmitters. Each of the 9 transmissions has the same variance.

FIG. 4B shows a replica of the transmission from one transmitter, generated by the client with a time origin the same as the actual transmission.

FIG. 4C shows the cross correlation of the replica with the total signal arriving at the receiver.

FIG. 5 shows the time duration of the transmitted signal required to provide 15 dB

$${( \frac{S}{N} )}_{cc}$$

as a function of range to the receiver for a sampling frequency 44 kHz and 96 kHz assuming the transmitted signal level is less than the ambient noise level at distances from the transmitter greater than 3 meters.

FIG. 6 shows a coordinate system for one example embodiment of a method according to the present disclosure.

FIG. 7 shows the standard deviations of the estimates of X, Y and Z for a received signal sample frequency of 96 kHz.

FIG. 8 shows shows the standard deviations of the estimates of X, Y and Z for a received signal sample frequency of 44 kHz.

### DETAILED DESCRIPTION

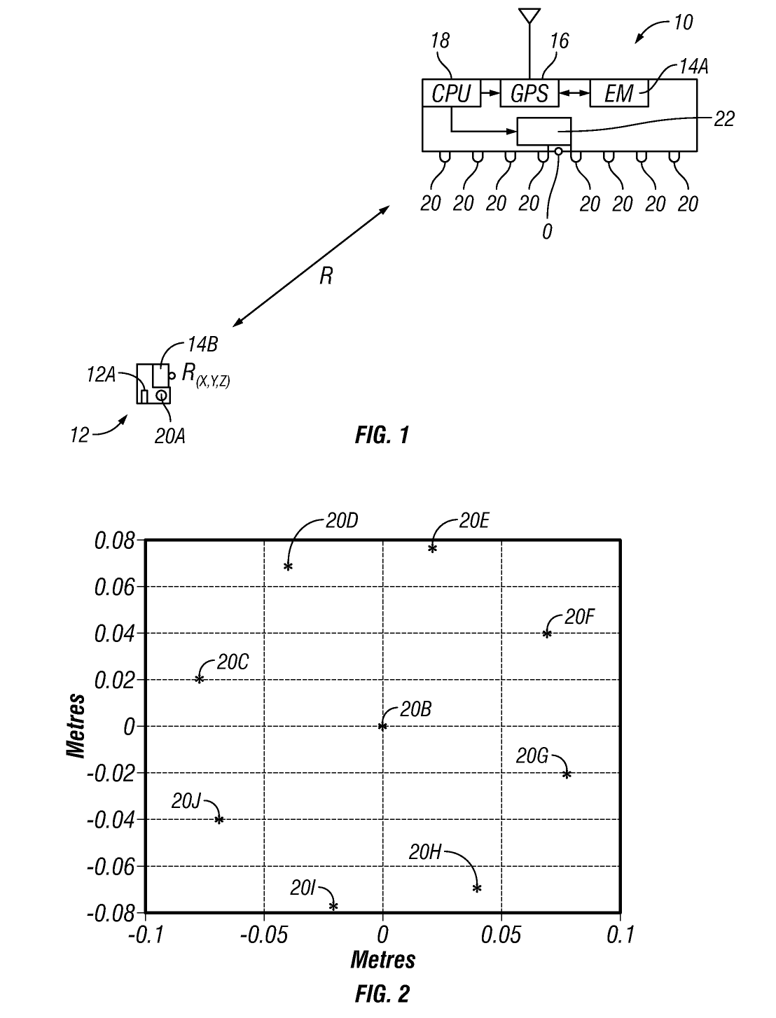

An example system for locating a mobile electronic device according to the present disclosure is shown in FIG. 1. The system may include a base station 10. The base station 10 may include an array of acoustic transmitters 20 arranged in a selected pattern. The acoustic transmitters 20 may be, for example, piezoelectric transducers or any type known in the art for acoustic signal transmission and detection. An example transmitter pattern will be further explained below with reference to FIG. 2. The base station 10 may include a central processor 18, which may be implemented any known form, including without limitation a microprocessor, microcontroller, floating programmable gate array or application specific integrated circuit. The central processor 18 may accept as input an absolute time reference signal, such as a global positioning system (GPS) time reference signal from a receiver 16 provided to detect such signals. An electromagnetic communication transceiver 14A may be included to communicate substantially instantaneously with one or more mobile electronic devices 12 disposed within a surveillance volume and for which the position is to be determined. The electromagnetic communication transceiver 14A may be a Bluetooth (Institute of Electrical and Electronics Engineers—IEEE 802.15.1) standard or other communication protocol device which can perform the communication of a time reference and/or other information substantially instantaneously. The electromagnetic communication transceiver 14A enables communication of a time synchronization signal and coding information for acoustic signals generated by the acoustic transmitters 20 to the one or more mobile electronic devices 12.

The central processor 18 may have stored thereon control signals used to operate a power amplifier 22. The power amplifier 22 provides amplified control signals (i.e. driver signals) to drive each of the transmitters 20. The control signals may be selected duration, coded signals that are substantially uncorrelated with each other. Examples of such control signals may include direct sequence, spread spectrum (DSSS) signals of a selected duration. The control signals may be, for example and without limitation, maximum length sequences, Gold-code sequences, Kasami-code sequences or pseudorandom binary code sequences. The control signals may be different for each transmitter 20. By having the different control signals be substantially uncorrelated with each other, the transmitters 20 may be operated substantially simultaneously, or at least partially contemporaneously, while enabling identification of the signal transmitted by each individual transmitter 20 in a composite detected acoustic signal.

The mobile electronic device 12 may be a “smartphone” or any other electronic device that may be moved within the surveillance volume and for which a position R is to be determined. The mobile electronic device 12 may include an electromagnetic communication transceiver 14B for communication of the above described signals between the base station 10 and the mobile electronic device 12. The mobile electronic device 12 may also include an acoustic receiver 20A for receiving acoustic signals emitted by the plurality of transmitters 20 on the base station 10. The mobile electronic device 12 may also include a processor 12A associated with the electromagnetic transceiver 14B and in signal communication with the acoustic receiver 20A. The processor 12A in the mobile electronic device may be any form of processor, including without limitation a microprocessor, field programmable gate array and application specific integrated circuit. The processor 12A may include instructions programmed therein for performing certain operations as will be further explained below. It is expected that the received acoustic signals (as well as electromagnetic signals) will be digitally sampled by the mobile electronic device 12 and processed in digital form. A digital sampling rate will affect the signal to noise ratio obtained with respect to a duration of each coded signal emitted by each of the acoustic transmitters 20 as will be further explained below.

A position coordinate system may be defined, for example, in Cartesian coordinates with an origin O defined at a selected position on the base station 10 and a position R (X, Y, Z) of the mobile electronic device 12 to be determined using methods according to the present disclosure. A distance R may be defined as the linear distance between the position R (X, Y, Z) and the origin O, and the position R may be defined in terms of displacement along three Cartesian coordinate axes, X, Y, Z from the origin O.

FIG. 2 shows an example arrangement of the transmitters on the base station (10 in FIG. 1). In some embodiments, the transmitters may be arranged in an array consisting of eight transmitters 20C through 20J equally spaced around the circumference of a circle of radius, for example, eight centimeters (cm) with a central transmitter 20B displaced normal to the plane of the circle by, for example, eight cm.

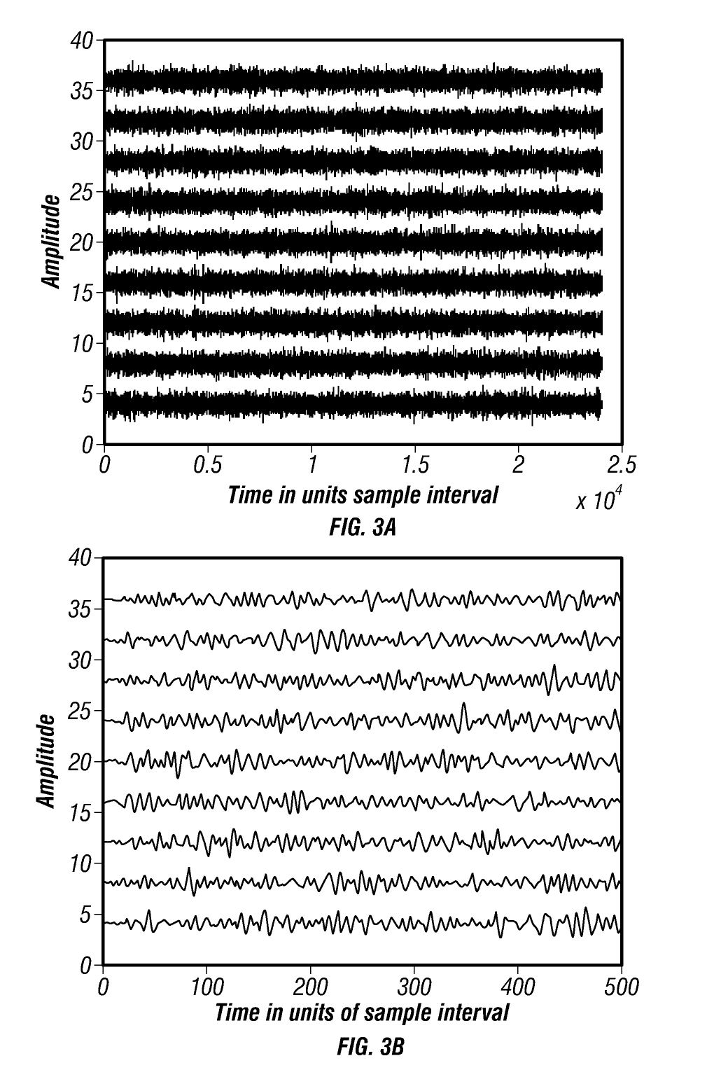

Each of the nine transmitters 20B through 20J may simultaneously transmit an acoustic signal, in the present example in a frequency range of about 5 kHz to 15 kHz. Each acoustic signal may be generated in software (e.g., as may be programmed into the central processor 18 in FIG. 1) with a different code, such that each acoustic signal is substantially decorrelated from the others. Examples are shown in FIGS. 3A and 3B.

The mobile electronic device (12 in FIG. 1) may have stored thereon the codes for each of the particular acoustic transmitter signals and can generate therein replicas of each of the transmitted acoustic signals. In other embodiments, the codes may be communicated between the base station (10 in FIG. 1) and the mobile electronic device (12 in FIG. 1) using the electromagnetic communication transceivers (14A, 14B in FIG. 1). A signal comprising uncorrelated coded signals generated by each acoustic transmitter 20B through 20J operating substantially simultaneously, or at least partially contemporaneously, may be referred to as a composite signal.

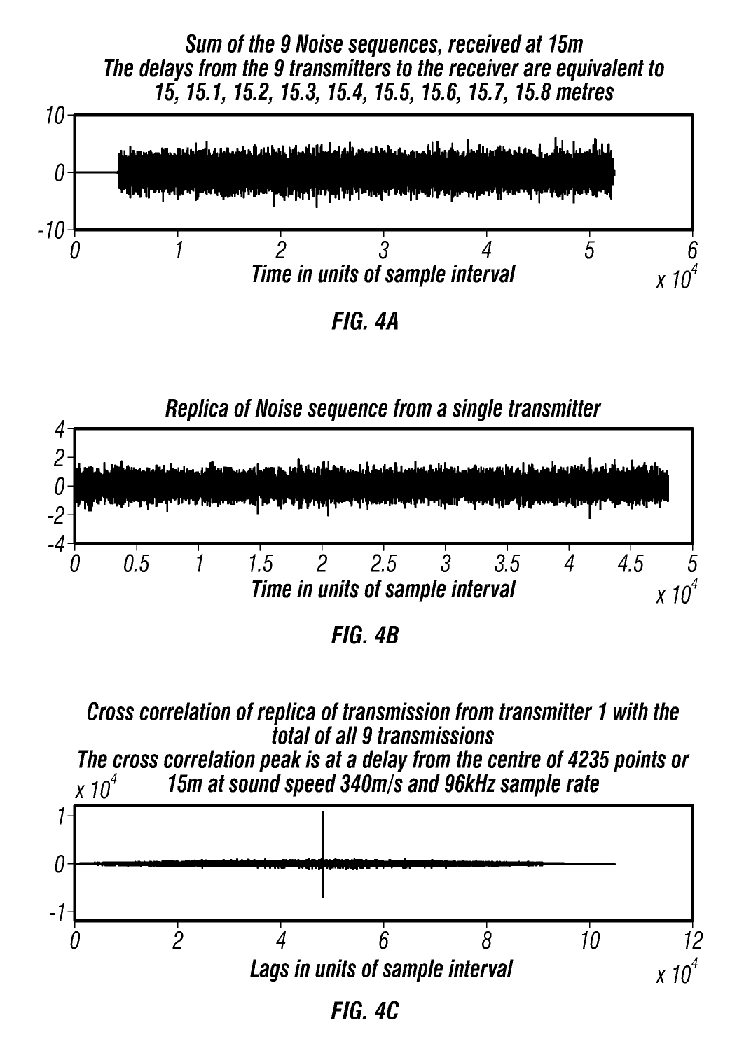

On detection of the composite signal at the receiver (20A in FIG. 1) in the mobile electronic device, in the present example embodiment the nine (Ns=9) individual transmitted sequence signals will be detected as a single acoustic signal which includes ambient noise, as shown in FIG. 4A. FIG. 4B shows a replica generated by the mobile electronic device (12 in FIG. 1), synchronized with the moment of transmission. Cross correlation of the replica with the detected composite signal produces a peak, shown in FIG. 4C, which provides the travel time from a particular acoustic transmitter, any one of 20B through 20J, to the mobile electronic device (12 in FIG. 1).

Ideally, a cross correlation between a replica of a selected coded signal using a code stored in or detected by the mobile electronic device, and the received signal should be zero except at the time delay experienced by the appropriate component of the received signal (i.e., the travel time of the acoustic signal from the respective acoustic transmitter and the acoustic receiver in the mobile electronic device). However, for the simple adoption of coded sequences each with its own separate code the cross correlations of replicas with noise-like sequences of different codes is not zero but provides a background against which it is expected that the desired peak in the cross correlation function will have sufficient amplitude for its delay time to be determined with the requisite accuracy.

After determining the time delays (i.e., travel time) of the signal emitted by each acoustic transmitter (20 in FIG. 1) at the mobile electronic device (12 in FIG. 1), in some embodiments, the electromagnetic transceiver (14B in FIG. 1) in the mobile electronic device may either or both: (i) communicate the arrival times to the base station (10 in FIG. 1) for determining the location R (X, Y, Z) of the mobile electronic device using the electromagnetic transceiver (14B in FIG. 1); and (ii) calculate the location R (X, Y, Z) of the mobile device in the mobile device itself and communicate the location calculated to the base station (10 in FIG. 1) using the electromagnetic transceiver (14B in FIG. 1). There may be situations in which it is not necessary to communicate the position R to the base station (10 in FIG. 1) or determine the position R in the base station (10 in FIG. 1). The mobile electronic device may calculate its position R with reference to the base station (10 in FIG. 1) and not communicate the calculated position R.

After cross correlation of the received signal with the appropriate coded sequence, as explained above, a peak in the cross correlation value provides the arrival time from any selected transmitter. In a situation in which multiple sound travel paths (e.g., from reflections) are present the first cross correlation peak will be followed in time by peaks of decreasing amplitude due to arrival of sound from multiple travel paths. In the present embodiment, therefore, the first cross correlation amplitude peak is used to determine arrival time. However the presence of multiple arrivals will increase the background above which the first cross correlation peak is to be detected. Simulations have shown that the foregoing effect, while not insignificant, does not materially affect the accuracy with which the arrival time of the first peak in the cross correlation can be obtained and does not detract from the robustness of the approach to the presence of multiples.

An indication of the signal to noise ratio in which the arrival time of the cross correlation peak may be extracted may be determined is as follows. First, calculate the signal to noise ratio for the arriving acoustic signals before any correlation processing is performed. x(t) is the time domain representation of a coded signal of duration Nₚ sample points whose arrival time is required and it is included in a signal having the Ns other coded noise signals noise therein in X(t) where the variance of X(t) is Nₛ times the variance of x(t). The signal to noise ratio (S/N) of x(t) in X(t) may be determined by the expression:

$${( S / N )}_{0} = 10 {log}_{10} ( \frac{energy in x}{energy in X} ) = 10 {log}_{10} ( \frac{{σ}_{x}^{2} {N}_{p}}{{σ}_{X}^{2} {N}_{p}} ) = 10 {log}_{10} ( \frac{{σ}_{x}^{2}}{{σ}_{X}^{2}} ) = 10 {log}_{10} ( \frac{{σ}_{x}^{2}}{{σ}_{x}^{2} {N}_{s}} ) = - 10 {log}_{10} ( {N}_{s} ) \qquad ( 1 )$$

where σₓ is the standard deviation of x(t). To detect the presence of x(t) in X(t) and thus to obtain its arrival time, the received signal is cross correlated with a replica of x(t), represented herein by ax(t). The relative amplitudes of the coded signals x(t) and the replica ax(t) do not need to be known. The signal to noise ratio relevant for detection of the cross correlation peak may be determined by the expression:

$${( \frac{S}{N} )}_{cc} = 10 {log}_{10} ( \frac{energy in cross correlation of ax with x}{energy in cross correlation of ax with X} ) \\ \begin{matrix}{( \frac{S}{N} )}_{cc} = 10 {log}_{10} ( \frac{{( a \sum {x}^{2} )}^{2}}{{( {σ}_{X} {σ}_{R} )}^{2} {N}_{p}} ) \\ = 10 {log}_{10} ( \frac{{( {aN}_{p} {σ}_{x}^{2} )}^{2}}{{( ( \sqrt{{σ}_{x}^{2} {N}_{s}} ) a {σ}_{x} )}^{2} {N}_{p}} ) \\ = 10 {log}_{10} ( \frac{{N}_{p}}{{N}_{s}} )\end{matrix} \qquad ( 2 )$$

where σ_{R} is the standard deviation of the replica and Nₚ is equivalent to the time bandwidth product. Nₛ is the total of the number of coded signals transmitted.

In terms of the above explanation, FIG. 4A shows X(t) and FIG. 4B shows one coded signal x(t) where X(t) is composed of nine coded signals, each with its own code. The signal to noise ratio at the receiver of x(t) in X(t) is:

(S/N)₀=−10 log₁₀(Nₛ)=−10 log₁₀(9)=−9.5 dB (3)

The duration of x(t) in the present example is 0.5 seconds at a sampling rate of 96 kHz giving the number of signal sample points Np=48,000. Thus the processing gain may be calculated as:

10 log₁₀(Nₚ)=47 dB

Therefore, the signal to noise

$${( \frac{S}{N} )}_{cc}$$

relevant for the extraction of the arrival time may be calculated by the expression:

$${( \frac{S}{N} )}_{cc} = 10 {log}_{10} ( \frac{{N}_{p}}{{N}_{s}} ) = 47 - 9.5 = 37.5 dB \qquad ( 4 )$$

This is substantially in agreement with FIG. 4C wherein the maximum value of the cross correlation is 10,800 and the standard deviation of the background noise is 213, giving a signal to noise of 20 log₁₀(10800/170)=36 dB.

In some embodiments, it may be desirable that the transmitted signals should not be intrusive to persons. The amplitude of the transmitted signals may therefore be set below the amplitude of ambient noise for distances from the acoustic transmitters (FIG. 2) greater than a distance defined as Rᵣ.

In order to obtain detectable line of sight acoustic signals at the one or more mobile electronic devices, the transmitters (20B through 20J in FIG. 2) may be disposed well above the expected positions R within the volume of the one or more mobile electronic devices. Thus Rᵣ may be selected to be, for example, 2 to 3 meters.

The signal amplitude at a distance Rᵣ from any one of the acoustic transmitters is

$${I}_{N} ( {R}_{r} ) = \frac{{N}_{s} {σ}_{x}^{2}}{{R}_{r}^{2}} \qquad ( 5 )$$

I_{N}(Rᵣ) is set to be the ambient noise level. At the receiver at range R the signal of interest is x(t) and its level is:

$${I}_{x} ( R ) = \frac{{σ}_{x}^{2}}{{R}^{2}} \qquad ( 6 )$$

At the acoustic receiver (20A in FIG. 1) the total transmitted signal is

$${I}_{T} ( R ) = \frac{{N}_{s} {σ}_{x}^{2}}{{R}^{2}} \qquad ( 7 )$$

Thus the signal to noise ratio at the acoustic receiver (20 in FIG. 1) is:

$${( S / N )}_{0} = 10 log ( \frac{{I}_{x} ( R )}{{I}_{N} ( {R}_{r} ) + {I}_{T} ( R )} ) = - 10 log ( {N}_{s} ( 1 + {( \frac{R}{{R}_{r}} )}^{2} ) \qquad ( 8 )$$

The signal to noise ratio for the extraction of the acoustic signal arrival time is:

$${( \frac{S}{N} )}_{cc} = 10 log ( {N}_{p} ) + {( S / N )}_{0} \qquad ( 9 )$$

By setting an example detection threshold such that

$${( \frac{S}{N} )}_{cc} > 15 dB$$

it may be ensured that the cross correlation peak will be sufficiently well defined that parabolic interpolation can be used to refine the arrival time to about 0.1 of the signal digital sampling interval. Setting the foregoing example threshold allows calculation of the needed duration of the transmitted coded signals to satisfy the threshold.

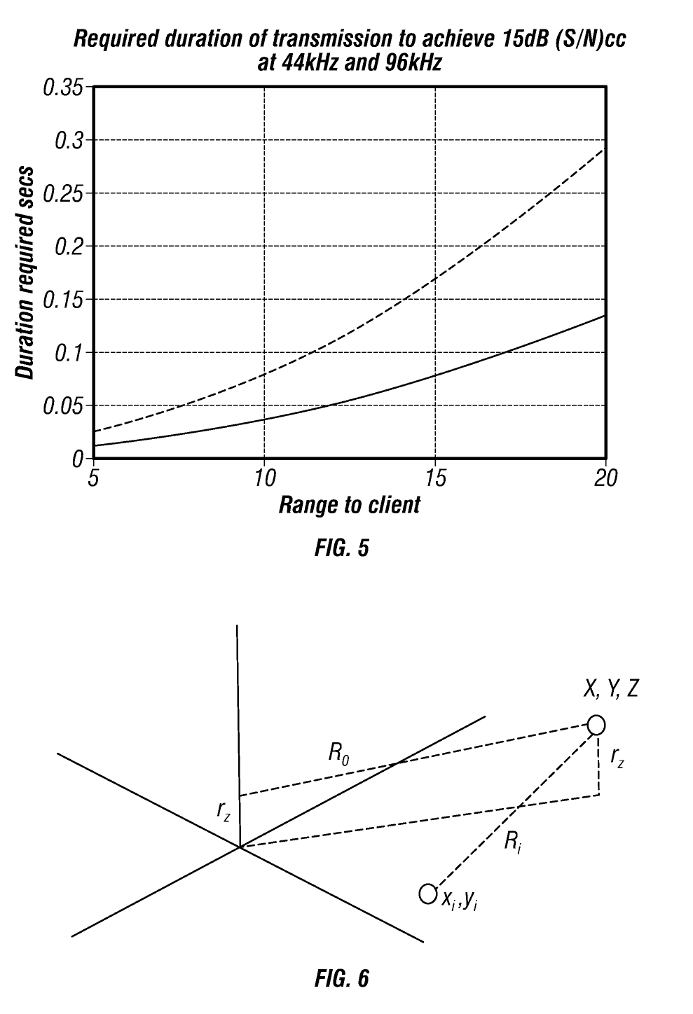

It may be observed in FIG. 5 that if the sampling rate is 96 kHz and the transmitted signal is less than the ambient noise at distances greater than 3 meters from the respective acoustic transmitter, that at acoustic receiver ranges of 20 meters, approximately 10 estimates of receiver position per second can be made. If the sampling rate is 44 kHz, the number drops to about 3 range estimates per second.

The example detection threshold for the

$${( \frac{S}{N} )}_{cc} \geq 15 dB$$

allows the position of the cross correlation peak in time to be determined with greater accuracy than the sampling interval. Parabolic interpolation around the peak allows the time difference to be determined to about 0.1 of a sampling interval. Errors in the mobile electronic device position determination, σ_{R}, will be taken as 0.1 of a sampling interval before any considerations of uncertainties/variability of the sound speed due to temperature.

The errors in the estimate of a coordinate of the mobile electronic device is a function of the geometry of the acoustic transmitters and the acoustic receiver, and the range and accuracy with which the acoustic signal travel time can be determined.

The acoustic transmitter array as explained in above example embodiment may consist of eight transmitters equally spaced around the circumference of a circle of radius of about 8 cm with an acoustic transmitter in the center of the circle and displaced normal to the plane of the circle by about 8 cm.

FIG. 6 shows an example coordinate system that may be used in defining the respective positions of the acoustic transmitters and the to-be-determined position R of the acoustic receiver in the mobile electronic device (12 in FIG. 1):

R₀²=X²+Y²+(Z−r_{z})² (10)

Rᵢ²=(X−xᵢ)²+(Y−yᵢ)²+(Z)² (11)

The acoustic transmitter array may be configured using the above described 8 transmitters around the circumference of a circle such that:

Σ₁⁸xᵢ=0 and Σ₁⁸yᵢ=0 (12)

The acoustic receiver coordinates may be determined as follows:

$$\begin{matrix}Y = \frac{( {x}_{i} - {x}_{j} ) ( {R}_{k}^{2} - {R}_{i}^{2} ) - ( {x}_{i} - {x}_{k} ) ( {R}_{j}^{2} - {R}_{i}^{2} )}{2 ( ( {x}_{i} - {x}_{j} ) ( {y}_{i} - {y}_{k} ) - ( {x}_{i} - {x}_{k} ) ( {y}_{i} - {y}_{j} ) )} & ( 13 ) \\ X = \frac{{R}_{j}^{2} - {R}_{i}^{2} - 2 Y ( {y}_{i} - {y}_{j} )}{2 ( {x}_{i} - {x}_{j} )} & ( 14 ) \\ X = \frac{{R}_{k}^{2} - {R}_{i}^{2} - 2 Y ( {y}_{i} - {y}_{k} )}{2 ( {x}_{i} - {x}_{k} )} & ( 15 ) \\ Z = \frac{C - {R}_{0}^{2} - ( {r}^{2} - {r}_{z}^{2} )}{2 {r}_{z}} & ( 16 )\end{matrix}$$

in which:

$$C = \frac{1}{8} {\sum }_{1}^{8} {R}_{i}^{2} \qquad ( 17 )$$

In the above formulae the values of i, j and k are selected from the range 1 to 8. (Selection of 3 from 8 can be performed in 56 ways.)

Particular selections of i, j and k produce estimates of X, Y which have different standard deviations of error. The estimate of Z uses all values of the Rᵢ. Note that Y is extracted from three values of range.

Having solved for Y, the value of X may be extracted from two values of range. The two range values used may be from the formula which provides the larger value of the difference of the acoustic receiver X coordinates. The extraction of Z uses all 9 measured ranges in the present example embodiment. However, extraction of Y and X may use only 3 values of measured range.

Using formulae for the standard deviation of the extraction of X and Y, triplets of the acoustic transmitters (i.e., subsets of three) may be selected that provide the smallest values of error. Differences between the standard deviations of the different triplets is small for the first 10 combinations in the sequence determined by the magnitude of their standard deviations

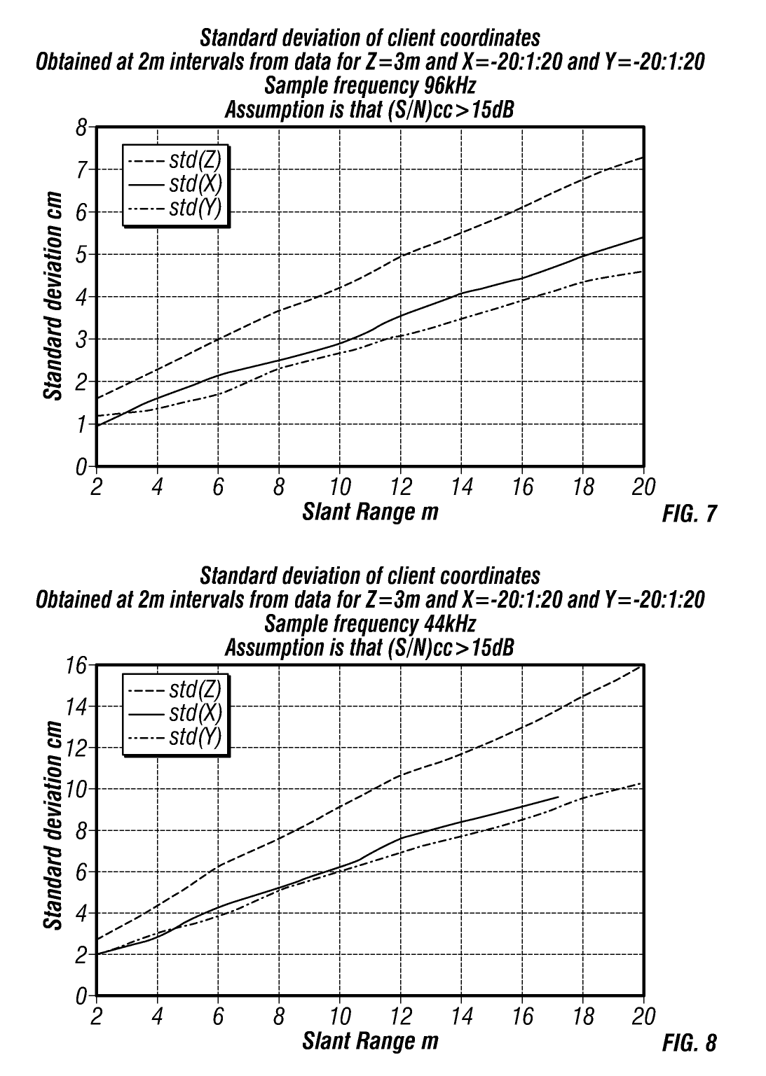

Given that the ranges may be determined to within 0.1 of the sampling interval as explained above, the standard deviations of the estimates of X, Y and Z are on average proportional to the range, as shown in FIG. 7. FIG. 8 shows a plot similar to FIG. 7, but wherein the sampling frequency is 44 kHz. The standard deviation of the error in the Z coordinates is:

$${σ}_{z} = \sqrt{( {\sum }_{1}^{8} {( \frac{{R}_{i}}{8 {r}_{z}} )}^{2} + {( \frac{{R}_{0}}{{r}_{z}} )}^{2} )} {σ}_{R} \approx \frac{{R}_{0}}{{r}_{z}} {σ}_{R} \qquad ( 18 )$$

where σ_{R} is the standard deviation of the measurement of ranges. The standard deviation of the error in the Y coordinates is:

$${σ}_{y} = \frac{\sqrt{( {{R}_{1}^{2} ( {x}_{j} - {x}_{k} )}^{2} + {{R}_{2}^{2} ( {x}_{i} - {x}_{k} )}^{2} + {{R}_{3}^{2} ( {x}_{i} - {x}_{j} )}^{2} )}}{( ( {x}_{i} - {x}_{j} ) ( {y}_{i} - {y}_{k} ) - ( {x}_{i} - {x}_{k} ) ( {y}_{i} - {y}_{j} ) )} {σ}_{R} \qquad ( 19 )$$

and the standard deviation of the error in the X coordinates is:

$${σ}_{x} = \sqrt{\frac{{R}_{i}^{2}}{{( {x}_{i} - {x}_{k} )}^{2}} {σ}_{R}^{2} + \frac{{R}_{k}^{2}}{{( {x}_{i} - {x}_{k} )}^{2}} {σ}_{R}^{2} + \frac{{( {y}_{i} - {y}_{k} )}^{2}}{{( {x}_{i} - {x}_{k} )}^{2}} {σ}_{y}^{2}} \qquad ( 20 )$$

It will be apparent to those skilled in the art that while the foregoing description of an example embodiment uses a plurality of transmitters in the base station (10 in FIG. 1) arranged in a selected pattern, and the mobile electronic device (12 in FIG. 1) has a receiver, a system and method according to the present disclosure may also be made using a transmitter in the mobile electronic device, wherein simultaneously operated, uncorrelated driver signals as explained above may be used to drive the transmitter, and the base station may comprise a plurality of receivers arranged in a selected pattern. The foregoing is possible by reason of the principle of reciprocity. Reference herein to transmitters and receivers for acoustic signal emission and detection may therefore be substituted by receivers and transmitters, respectively.

In embodiments using one transmitter and a plurality of receivers then only one acoustic transmitter driver signal is needed. Using a coded driver signal as described herein is still desirable so that low amplitude signals can be used to avoid annoyance. The arrival time of the signal at each of the receivers in such embodiments may still be performed by cross-correlation to make the determination robust against noise and most importantly against multipath arrivals. The arrival time at each receiver may be determined without the need for more than one transmitter driver signal. In such embodiments, the reciprocity is in the travel time between the single transmitter and the plurality of receivers. In embodiments using one transmitter and a plurality of receivers, the mobile electronic device would need the acoustic transmitter and as a practical matter would need to have sufficient power storage to drive the acoustic transmitter.

A system and method according to the present disclosure for locating a mobile electronic device within a volume may provide increase accuracy in position determination where a geodetic location system signal is unavailable or does not provide sufficient accuracy in position determination. The system and method may also provide improved ability to locate position in the presence of background noise and without disturbing people in the volume. Further, the system and method may provide more robust determination of position in the presence of multipath signal arrivals resulting from reflection of acoustic energy from surfaces within a surveillance volume.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for locating a mobile electronic device within a volume, comprising:
a plurality of acoustic transmitters arranged in a selected pattern within the volume;
a first processor in signal communication with each of the plurality of acoustic transmitters, the first processor having instructions therein to drive each of the plurality of transmitters with a different coded driver signal, the different driver signals substantially decorrelated with each other;
an electromagnetic signal transceiver in signal communication with the first processor, wherein the first processor has instructions therein to communicate a time reference signal to the mobile electronic device;
the mobile electronic device including an acoustic receiver for detecting signals from the plurality of acoustic transmitters and an electromagnetic transceiver for receiving from the processor at least a time reference signal;
wherein the mobile electronic device includes a second processor having instructions programmed therein for cross-correlating signals detected by the acoustic receiver with a replica of the signal of each of the different coded driver signals, the second processor including instructions programmed therein for calculating an acoustic travel time of acoustic signals between each transmitter and the acoustic receiver from the cross-correlated signals; and
wherein at least one of the first processor and the second processor is programmed to determine the position of the mobile electronic device from the travel times.

2. The system of claim 1 wherein the first processor includes instructions thereon to generate direct sequence spread spectrum signals to drive each of the plurality of acoustic transmitters.

3. The system of claim 1 wherein at least one of the first processor and the second processor includes instructions programmed therein to calculate a standard deviation of errors in the determined position, the processor including instructions programmed therein to select the determined position from a subset of signals received from each of the plurality of transmitters wherein a variance of the subset is a minimum.

4. The system of claim 1 wherein each acoustic transmitter emits a signal having an amplitude below an ambient noise level in the volume at a selected distance from each acoustic transmitter.

5. The system of claim 1 wherein a length of each coded signal is such that a threshold signal to noise is exceeded in the cross-correlated signals to enable acoustic travel time determination within a selected fraction of a detected acoustic signal sample interval.

6. The system of claim 1 wherein the selected pattern comprises a circle, and wherein the circle includes one of the plurality of acoustic transmitters disposed at a center thereof.

7. The system of claim 7 wherein the acoustic transmitter disposed at the center of the circle is displaced from a plane of the circle.

8. A method for locating a mobile electronic device within a volume, comprising:
emitting a plurality of different, coded, substantially decorrelated acoustic signals substantially simultaneously from each of a plurality of known locations within the volume;
detecting the acoustic signals at the mobile electronic device;
determining an acoustic travel time from each known location to the mobile electronic device by cross-correlating the detected acoustic signals with a replica of each of the emitted signals; and
determining a position of the mobile device using the travel times and the known locations.

9. The method of claim 8 wherein the plurality of coded signals comprises direct sequence spread spectrum signals.

10. The method of claim 1 wherein the emitted acoustic signals have an initial amplitude selected to be below an ambient noise level within the volume at a selected distance from each of the known locations.

11. The method of claim 8 wherein a length of each coded signal is such that a threshold signal to noise is exceeded in the cross-correlated signals to enable acoustic travel time determination within a selected fraction of a detected acoustic signal sample interval.

12. The method of claim 8 wherein the known locations form a circle, and wherein the circle includes one of the known locations disposed at a center thereof.

13. The method of claim 12 wherein the known location at the center of the circle is displaced from a plane of the circle.

14. The method of claim 8 wherein the determined position is calculated from a subset of signals received from each of the plurality of known locations wherein a variance of the subset is a minimum.
